(19) United States
(12) Patent Application Publication
(10) Pub. No.: US 2025/0356282 A1
(43) Pub. Date: Nov. 20, 2025

(54) ROBUST LONG-TERM RESOURCE USAGE FORECASTING AND MULTI-TREND CLASSIFICATION

(71) Applicant: Palo Alto Networks, Inc., Santa Clara, CA (US)

(72) Inventor: Deokwoo Jung, Santa Clara, CA (US)

(21) Appl. No.: 18/667,978

(22) Filed: May 17, 2024

(51) Int. Cl. G06Q 10/0631; G06N 20/00

(52) U.S. Cl. CPC G06Q 10/06313; G06N 20/00

(57) ABSTRACT

The present application discloses a method, system, and computer system for generating a forecast, such as a long-term capacity resource forecast, based on a forecast model for a system activity. The method includes (a) processing and recursively modelling a set of resampled metric data in connection with segmenting the metric data into relevant data and non-relevant data to obtain a forecast model for system activity, wherein the set of resampled metric data pertains to the system activity, and (b) generating a forecast based at least in part on the forecast model for the system activity.

### BACKGROUND OF THE INVENTION

Next Generation Firewall (NGFW) devices generate diverse telemetry data, including traffic, configuration, and system resources, at varying time intervals from 20 minutes to 24 hours. Network Security (NetSec) administrators require an efficient method to analyze these long-term telemetry metrics because such metrics significantly impact network and security operations. This need is even more pronounced in multi-tenant environments where understanding correlated trends across telemetry metrics and devices within a tenant can be used to optimize security postures, device resources, and upgrade planning.

### BRIEF DESCRIPTION OF THE DRA WINGS

Various embodiments of the invention are disclosed in the following detailed description and the accompanying drawings.

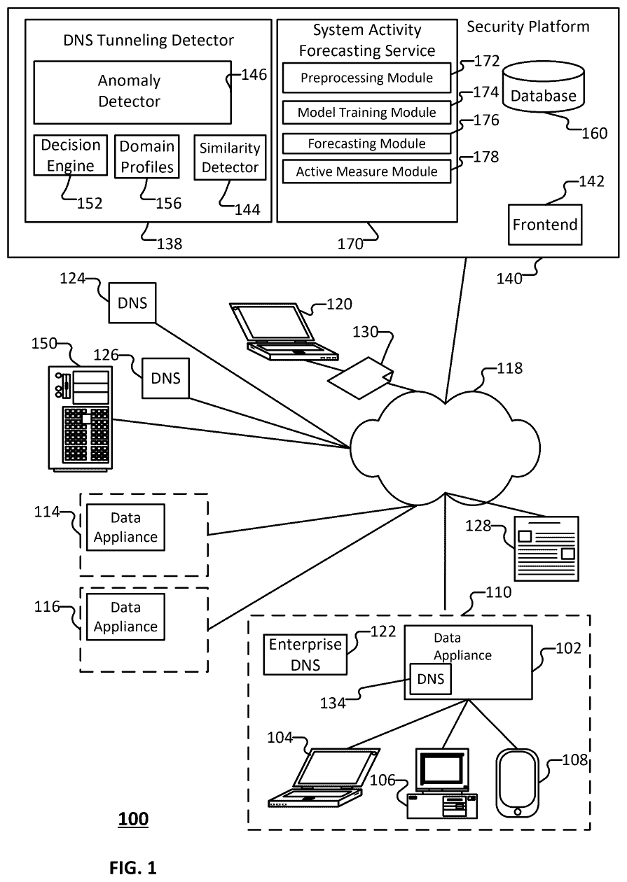

FIG. 1 is a block diagram of an environment in which a security service is provided according to various embodiments.

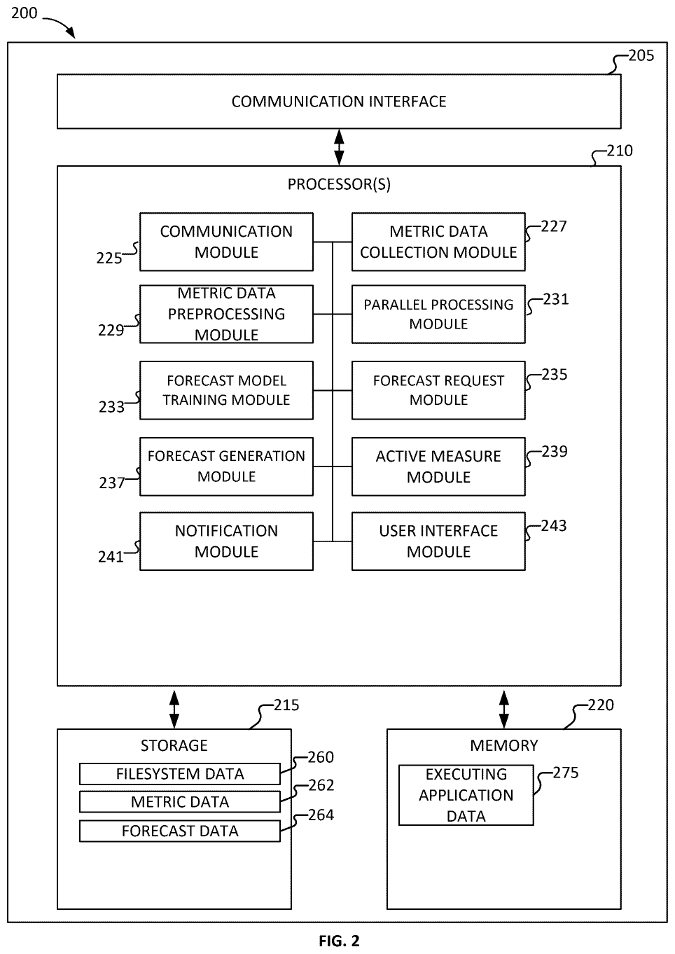

FIG. 2 is a block diagram of a system to forecast system activity or requirements according to various embodiments.

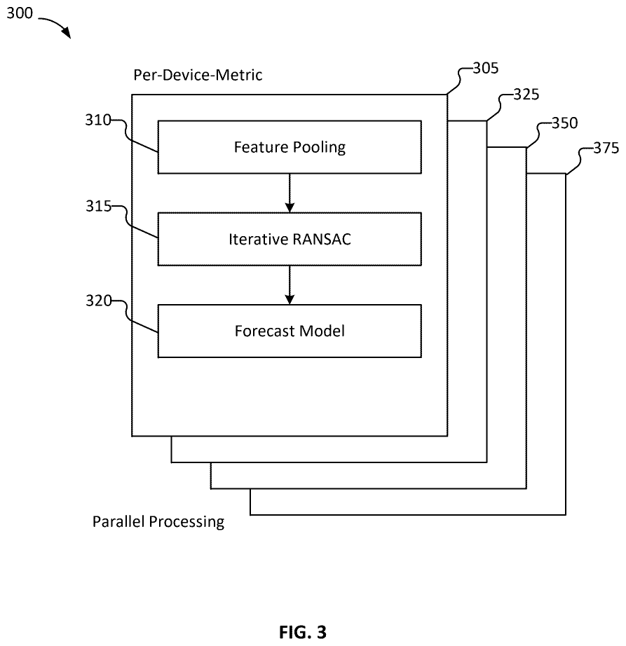

FIG. 3 is a block diagram of a system for training a forecast model according to various embodiments.

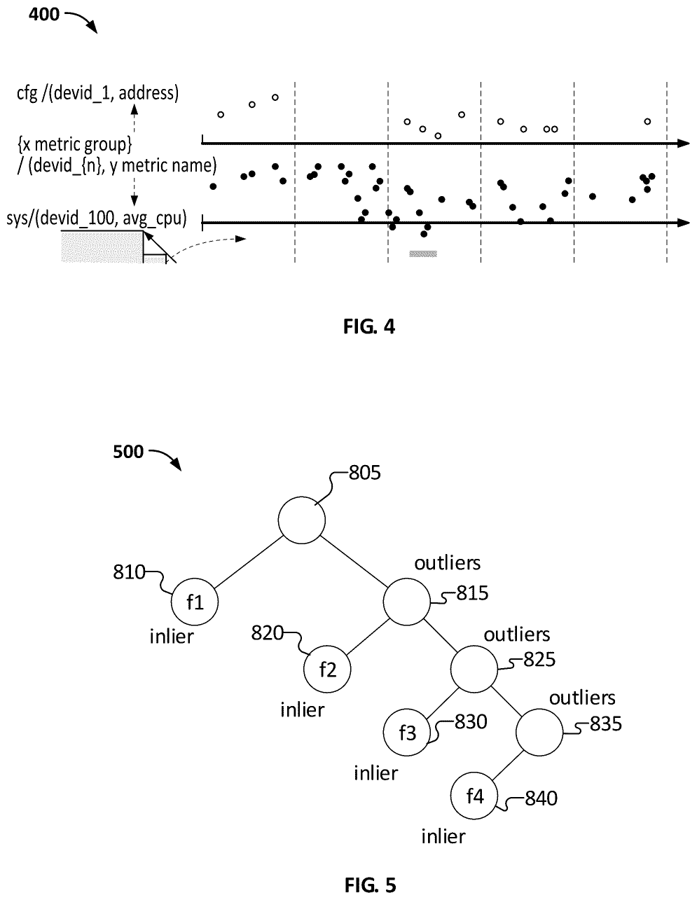

FIG. 4 is an illustration of resampled metric data according to various embodiments.

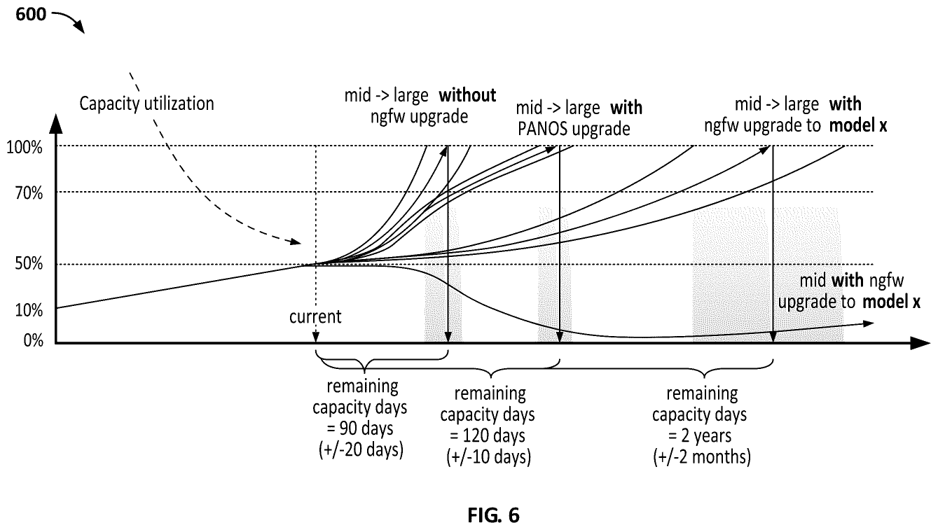

FIG. 5 is an illustration of sampled subsets of resampled metric data according to various embodiments.

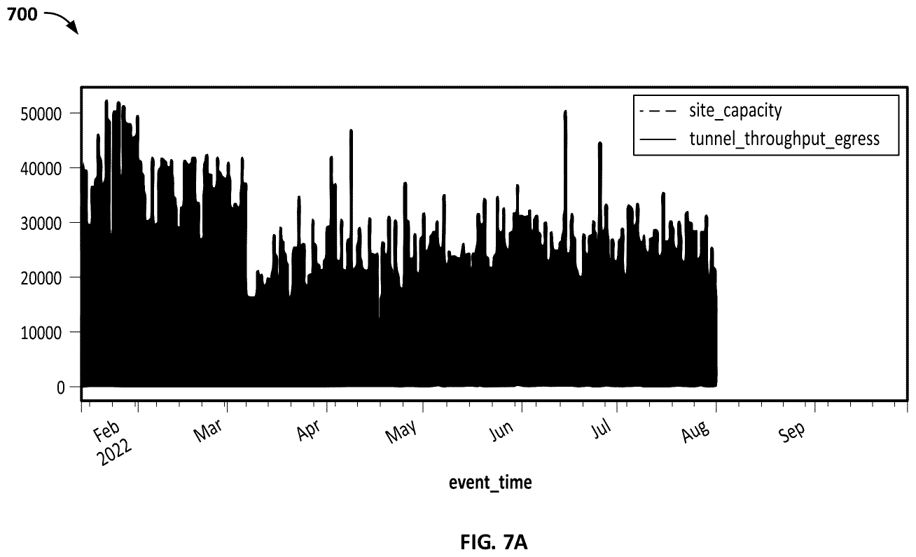

FIG. 6 is an illustration of a capacity utilization forecast generated using a forecast model according to various embodiments.

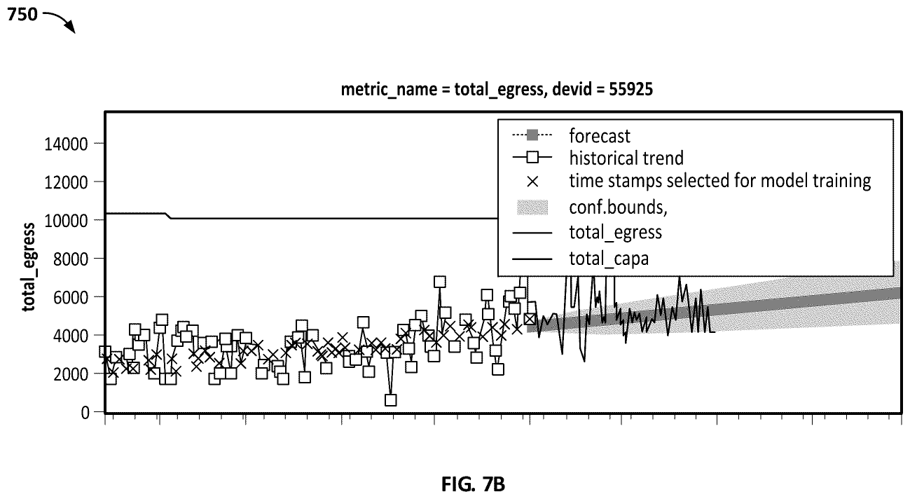

FIG. 7A is an illustration of metric data for a particular metric.

FIG. 7B is an illustration of a bandwidth capacity forecast generated using a forecast model based on resampled metric data according to various embodiments.

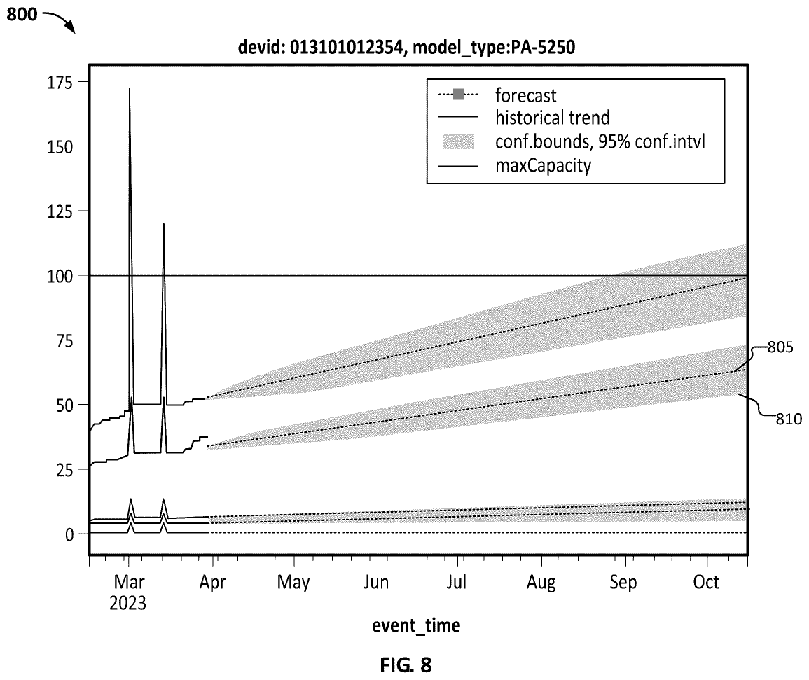

FIG. 8 is an illustration of a capacity forecast generated using a forecast model according to various embodiments.

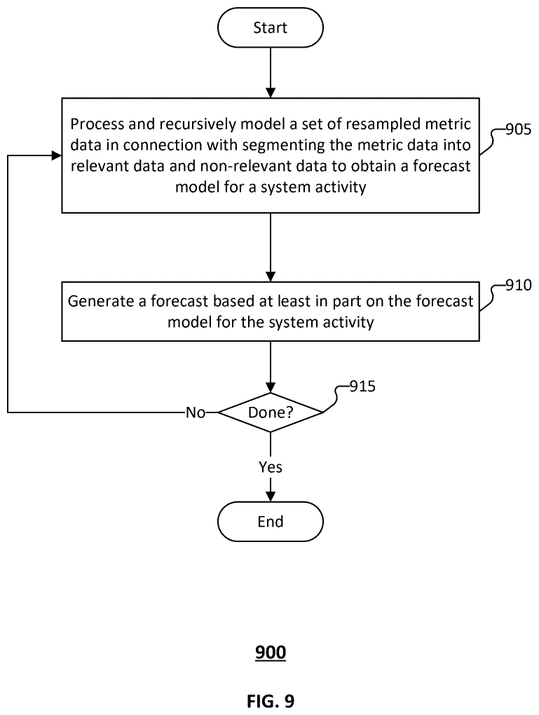

FIG. 9 is a flow diagram of a method for generating a forecast according to various embodiments.

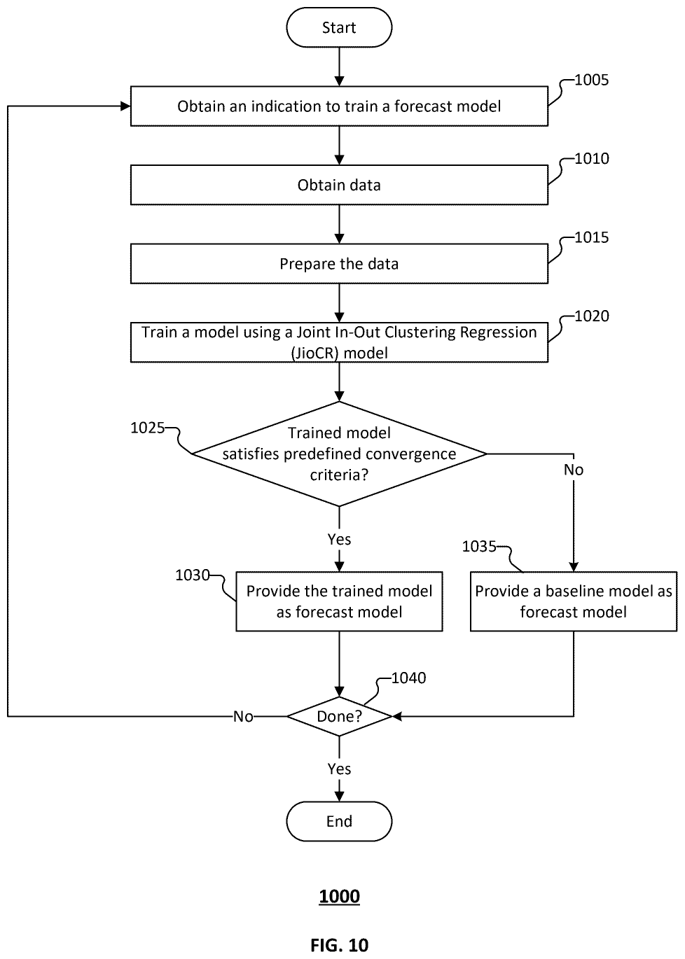

FIG. 10 is a flow diagram of a method for training a forecast model according to various embodiments.

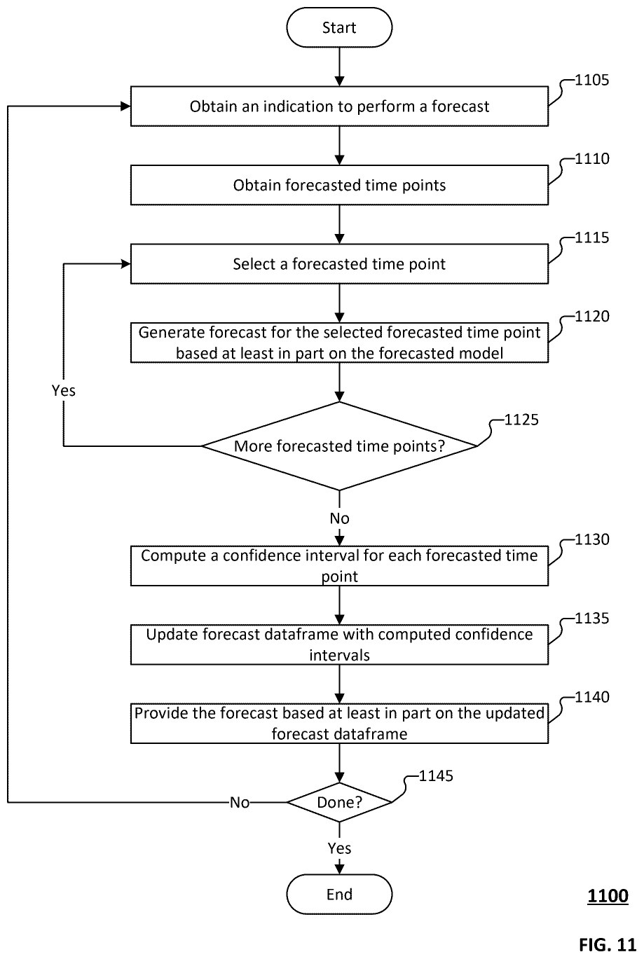

FIG. 11 is a flow diagram of a method for generating a forecast using a forecast model according to various embodiments.

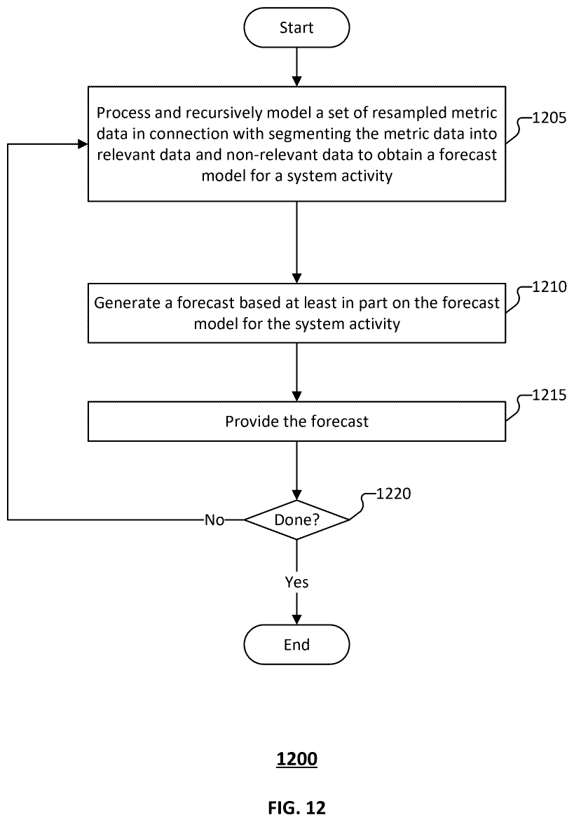

FIG. 12 is a flow diagram of a method for generating a forecast according to various embodiments.

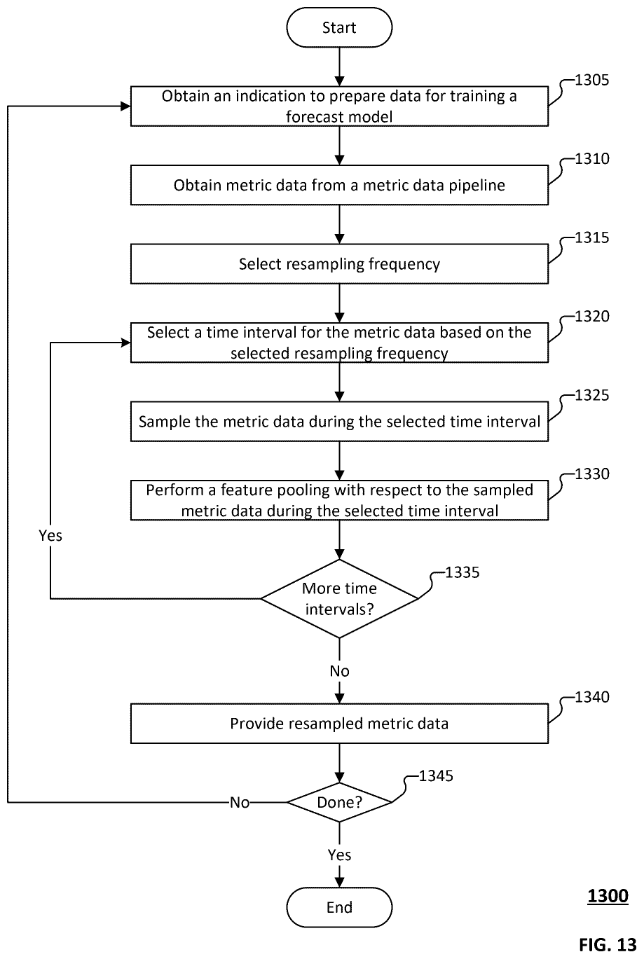

FIG. 13 is a flow diagram of a method for preprocessing metric data for use in training a forecast model according to various embodiments.

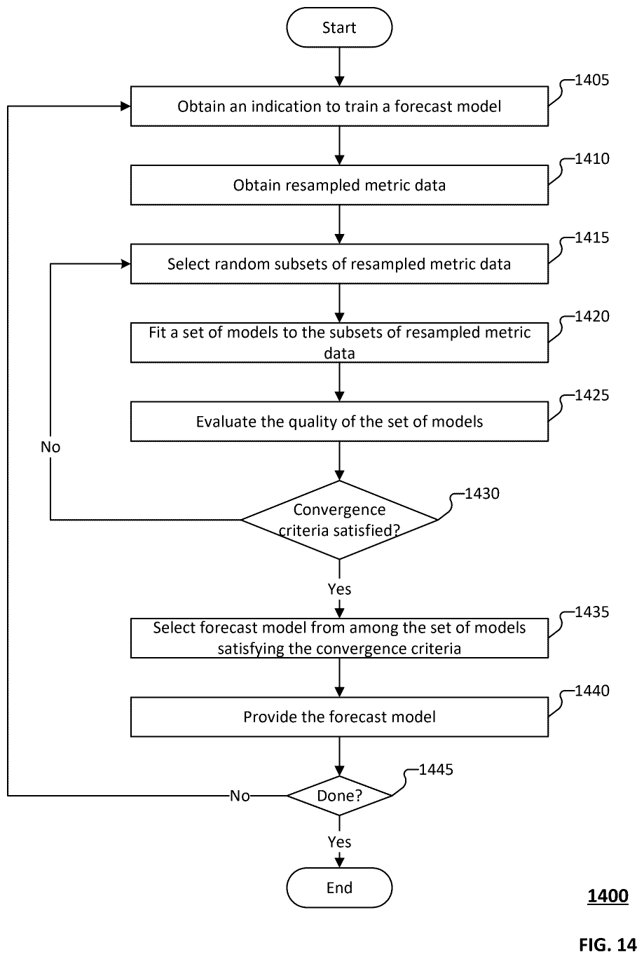

FIG. 14 is a flow diagram of a method for generating a forecast according to various embodiments.

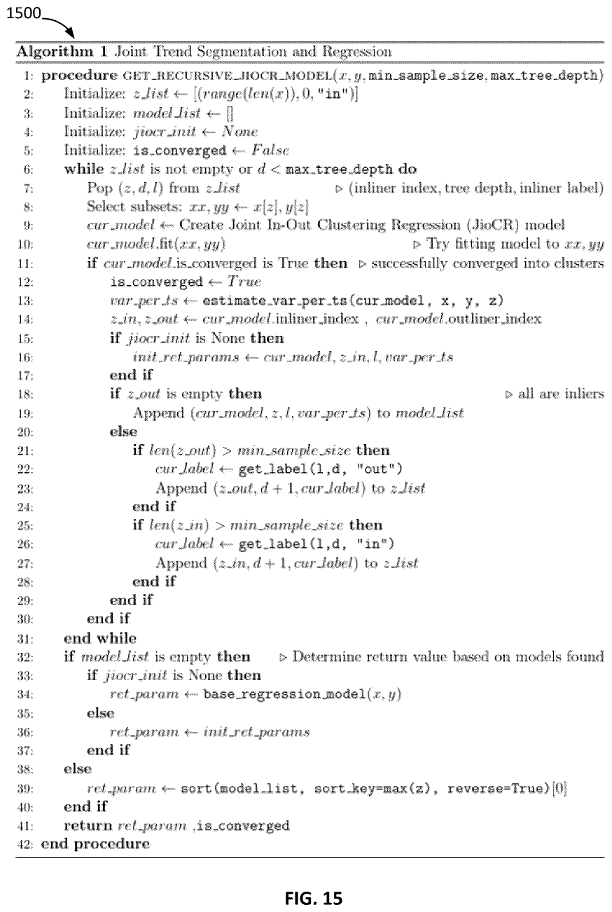

FIG. 15 is sample code for a joint rend segment and regression algorithm used to train a forecast model according to various embodiments.

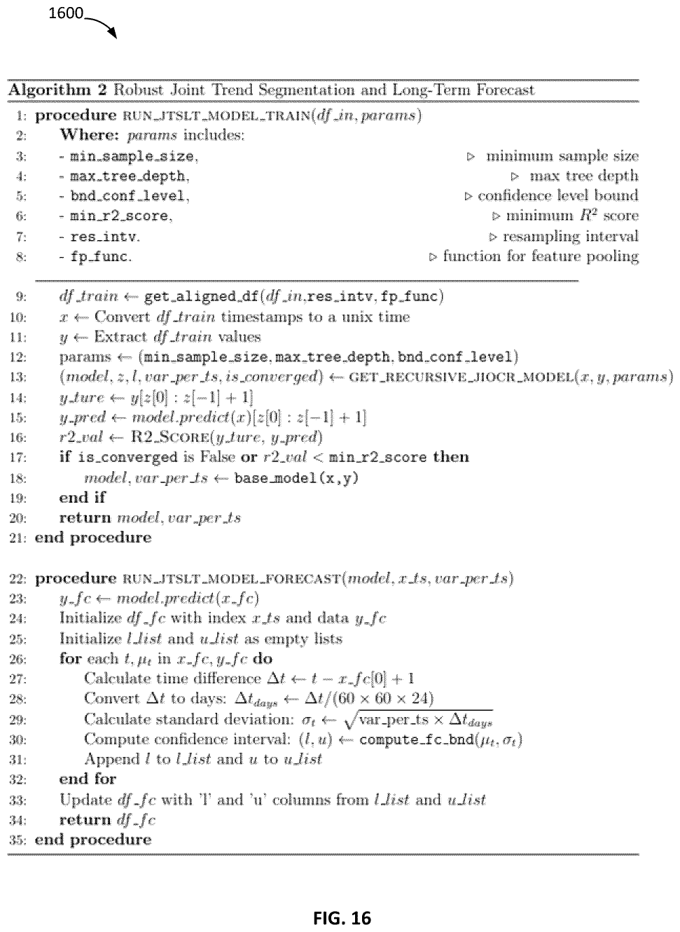

FIG. 16 is sample code training a forecast model and using the forecast model for generating a forecast according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Inherent complexities in the telemetry data, such as multiple trends and periodic cycles, pose significant challenges to long-term forecasting. Simple regression models implemented by some related art systems often prove to be sensitive to minor changes or data drift, limiting their robustness against seasonality or operational state changes initiated by configuration setting alterations or software updates. On the other hand, complex models like Deep Neural Networks, while capable of handling such intricacies, suffer from other problems such as overfitting, high computational cost, and data irregularities stemming from data loss, different telemetry time intervals, and co-linearity across devices and metrics.

Hence, there is a need for an effective and efficient approach to long-term telemetry data analysis, capable of capturing the multi-faceted nature of telemetry metrics while ensuring robustness against the inherent challenges in the data and mitigating computational expenses.

Various embodiments implement a resampled metric data pipeline and iterative resampled metric segmentation using the RANSAC (Random Sample Consensus) algorithm until a pre-defined convergence criterion is met. The primary feature metric in this solution is a resampled one, such as resampled metric data obtained by performing a feature pooling with respect to the underlying metric data. As an example, the feature pooling applied to the metric data is a max pooling over a predefined time interval (e.g., a max pooling technique that obtains/computes the maximum values per day). This metric resampling enables uniformity in time intervals during model training, regardless of the metric type, and significantly reduces the number of samples and noise, thereby enhancing long-term forecasting capabilities.

Various embodiments uses a breadth-first search binary tree search strategy that progressively partitions the resampled metric into inliers and outliers using the RANSAC algorithm. This process recurs on the outliers subset until all input data is either classified as an inlier or the remaining sample size is smaller than a pre-set minimum (e.g., defaulted to 7 samples). With the reduction in input data achieved through max resampling, the RANSAC algorithm can operate more computationally efficiently. In some embodiments, the default kernel function for the RANSAC algorithm is linear regression. However, various other types of kernel functions can be implemented, such as exponential or polynomial functions. The kernel function can be selected based on the nature of the inlier input data. Through the iterative breadth-first search using the RANSAC algorithm, the input data is segmented on a binary tree across the resampled metric sample. The most recent valid segmentation, determined by the minimum number of samples and model fitness criteria, serves as the long-term forecast model. This method exhibits robustness to outliers and system state changes (such as OS or configuration updates). By linking these segmentations to system logs, the system can learn and understand the context of these segments. This learned context can then be used to detect security incidents or system operation events, enhancing overall system insights and responses.

Current solutions often struggle to tackle the multi-trend embeddings in telemetry data, leading to forecast models that are extremely sensitive to changes in network device configurations, software updates, or security policy alterations. This sensitivity results in models overfitting to outlier events or underfitting and failing to encompass all trends in the telemetry data. Typically, final forecast services necessitate human labels for manual event segmentation during the pre-deployment development phase or post-deployment based on customer feedback. In contrast, various embodiments provide the following advantages: (a) automation, (b) noise reduction and time complexity, (c) scalability, (d) flexibility, and (e) extensibility. Each of these advantages are further described below:
Automation: the system or forecast model training technique according to various embodiments automates the segmentation of trends, thereby eliminating or significantly reducing the need for human labeling, making the process more efficient and less prone to human error.
Noise Reduction and Time Complexity: the use of max-pooling in resampled metric outputs can reduce noise and the time complexity of the forecast pipelines by a factor of 100×, enhancing the efficiency and accuracy of long-term forecasting.
Scalability: the forecast model training technique is highly scalable with respect to the number of tenants, as it supports massive parallel processing over device metrics. This feature makes the technique disclosed herein adaptable to growing networks without significant losses in performance.
Flexibility: the system is highly flexible in terms of the regression models used (linear by default, but can be polynomial or others), allowing it to adapt to varying data trends and enhance its predictive performance. · Extensibility: the system or forecast model training technique is easily extensible to a multivariate model, which can incorporate more factors into the forecast, thus making the predictions more robust and comprehensive.

Various embodiments provide method, system, and computer system for generating a forecast, such as a long-term capacity resource forecast, based on a forecast model for a system activity. The method includes (a) processing and recursively modelling a set of resampled metric data in connection with segmenting the metric data into relevant data and non-relevant data to obtain a forecast model for system activity, wherein the set of resampled metric data pertains to the system activity, and (b) generating a forecast based at least in part on the forecast model for the system activity.

FIG. 1 is a block diagram of an environment in which a security service is provided according to various embodiments. In some embodiments, system 100 is implemented by at least part of system 200 of FIG. 2, and/or system 300 of FIG. 3.

In the example shown, client devices 104-108 are a laptop computer, a desktop computer, and a tablet (respectively) present in an enterprise network 110 (belonging to the “Acme Company”). Data appliance 102 is configured to enforce policies (e.g., a security policy, a network traffic handling policy, etc.) regarding communications between client devices, such as client devices 104 and 106, and nodes outside of enterprise network 110 (e.g., reachable via external network 118). Examples of such policies include policies governing traffic shaping, quality of service, and routing of traffic. Other examples of policies include security policies such as ones requiring the scanning for threats in incoming (and/or outgoing) email attachments, website content, inputs to application portals (e.g., web interfaces), files exchanged through instant messaging programs, and/or other file transfers. Other examples of policies include security policies (or other traffic monitoring policies) that selectively block traffic, such as traffic to malicious domains or parked domains, or traffic for certain applications (e.g., SaaS applications), or malicious or invalid authentication requests. In some embodiments, data appliance 102 is also configured to enforce policies with respect to traffic that stays within (or from coming into) enterprise network 110.

Techniques described herein can be used in conjunction with a variety of platforms (e.g., desktops, mobile devices, gaming platforms, embedded systems, etc.) and/or a variety of types of applications (e.g., Android .apk files, iOS applications, Windows PE files, Adobe Acrobat PDF files, Microsoft Windows PE installers, etc.). In the example environment shown in FIG. 1, client devices 104-108 are a laptop computer, a desktop computer, and a tablet (respectively) present in an enterprise network 110. Client device 120 is a laptop computer present outside of enterprise network 110.

Data appliance 102 can be configured to work in cooperation with remote security platform 140. Security platform 140 can provide a variety of services, including network security services, metric data collection (e.g., telemetric metrics), forecasting various metrics pertaining to system 100 (e.g., network activity, security platform 140 activity, etc.), training forecast models, etc. The metrics that can be forecasted by security platform 140 (e.g., based on using one or more forecast models) include, without limitation, resource capacity, resource utilization, expected time at which resource usage equals the corresponding resource capacity or a predefined percentage of the resource capacity, etc.

According to various embodiments, examples of services provided by security platform 140 include (a) managing/maintaining a security policy configuration(s) for enterprise network 110 and/or devices connected to enterprise network 110 (e.g., managed devices, security entities, etc.), (b) enforcing the security policy configuration or causing a security entity (e.g., a firewall) to enforce the security policy configuration, (c) classifying network traffic, (d) classifying authentication requests and/or connection requests, (c) determining a manner by which authentication requests and/connection requests are to be handled (e.g., based at least in part on a predicted authentication classification, etc.), (f) training a machine learning (ML) model to generate predictions with respect to network traffic classifications, (g) generating or validating a proof of possession token, (h) obtaining (e.g., from a security portal) an authentication token, (i) authenticating a user, (j) generating an updated connection request, (k) serving as a proxy for a web service, (l) processing an updated connection request, and/or (m) performing an active measure with respect to network traffic (e.g., authentication requests) or files communicated across the network based on an instruction from another service or system or based on security platform 140 using a classifier (e.g., an ML model, a rule-based model, etc.) to generate a prediction with respect to the network traffic (e.g., a prediction of whether the network traffic, or session data for a particular traffic protocol, is malicious).

Security platform 140 may implement other services, such as determining an attribution of network traffic to a particular DNS tunneling campaign or tool, indexing features or other DNS-activity information with respect to particular campaigns or tools (or as unknown), classifying network traffic (e.g., identifying application(s) to which particular samples of network traffic corresponding, determining whether traffic is malicious, detecting malicious traffic, detecting C2 traffic, etc.), providing a mapping of signatures to certain traffic (e.g., a type of C2 traffic,) or a mapping of signatures to applications/application identifiers (e.g., network traffic signatures to application identifiers), providing a mapping of IP addresses to certain traffic (e.g., traffic to/from a client device for which C2 traffic has been detected, or for which security platform 140 identifies as being benign), performing static and dynamic analysis on malware samples, assessing maliciousness of domains, determining whether domains are parked domains, providing a list of signatures of known exploits (e.g., malicious input strings, malicious files, malicious domains, etc.) to data appliances, such as data appliance 102 as part of a subscription, detecting exploits such as malicious input strings, malicious files, or malicious domains (e.g., an on-demand detection, or periodical-based updates to a mapping of domains to indications of whether the domains are malicious or benign), providing a likelihood that a domain is malicious (e.g., a parked domain) or benign (e.g., an unparked domain), determining and/or providing an indication or a likelihood that authentication request is malicious, determining and/or providing an indication or a likelihood that network traffic for a particular traffic protocol (e.g., HTTP session data) is malicious, determining a model score, providing/updating a whitelist of input strings, files, domains, source addresses, destination address, authentication requests, or other characteristics or attributes of network traffic deemed to be benign, providing/updating input strings, files, domains, source addresses, destination address, authentication requests, or other characteristics or attributes of network traffic deemed to be malicious, identifying malicious input strings, detecting malicious input strings, detecting malicious files, predicting whether input strings, files, or domains are malicious, and providing an indication that an input string, file, or domain is malicious (or benign).

In some embodiments, system activity forecasting service 170 is a service for training forecast models to generate forecasts for certain metrics (e.g., metrics pertaining to network activity, system activity, and/or network security service activity, etc.) and/or use trained forecast models to generate forecasts (e.g., upon request or in accordance with a predefined frequency or schedule). System activity forecasting service 170 processes metric data to obtain resampled metric data to be used to train forecast models and then implements a training technique until the training technique determines a model that satisfies a predefined convergence criteria or earlier if another stop criteria is satisfied.

Although the example shows that security platform 140 comprises system activity forecasting service 170, in various other embodiments, the system activity forecasting service 170 may be implemented by another server(s)/service.

Security platform 140 may be further configured to classify network traffic, such as to determine whether the traffic is malicious or benign, or to determine a likelihood that the traffic is malicious or benign. Security platform 140 can store one or more classifiers (e.g., rule-based models, machine learning models, etc.). For example, Security platform 140 implements a classifier for predicting whether authentication requests or connection requests (e.g., received from a proxy or client device) are malicious/benign. Security platform 140 can further store/implement one or more security policies, such as a traffic-handling policy, according to which security platform 140 causes the network traffic (e.g., the authentication requests) to be handled.

In various embodiments, security platform 140 comprises one or more dedicated commercially available hardware servers (e.g., having multi-core processor(s), 32G+ of RAM, gigabit network interface adaptor(s), and hard drive(s)) running typical server-class operating systems (e.g., Linux). Security platform 140 can be implemented across a scalable infrastructure comprising multiple such servers, solid state drives, and/or other applicable high-performance hardware. Security platform 140 can comprise several distributed components, including components provided by one or more third parties. For example, portions or all of security platform 140 can be implemented using the Amazon Elastic Compute Cloud (EC2) and/or Amazon Simple Storage Service (S3). Further, as with data appliance 102, whenever security platform 140 is referred to as performing a task, such as storing data or processing data, it is to be understood that a sub-component or multiple sub-components of security platform 140 (whether individually or in cooperation with third party components) may cooperate to perform that task. As one example, security platform 140 can optionally perform static/dynamic analysis in cooperation with one or more virtual machine (VM) servers. An example of a virtual machine server is a physical machine comprising commercially available server-class hardware (e.g., a multi-core processor, 32+Gigabytes of RAM, and one or more Gigabit network interface adapters) that runs commercially available virtualization software, such as VMware ESXi, Citrix XenServer, or Microsoft Hyper-V. In some embodiments, the virtual machine server is omitted. Further, a virtual machine server may be under the control of the same entity that administers security platform 140 but may also be provided by a third party. As one example, the virtual machine server can rely on EC2, with the remainder portions of security platform 140 provided by dedicated hardware owned by and under the control of the operator of security platform 140.

In some embodiments, system activity forecasting service 170 is implemented as a service to provide administrators with robust forecasts for long-term telemetry metrics, including forecasts for multi-device and/or multi-tenanted environments.

In some embodiments, system activity forecasting service 170 implements one or more techniques for training forecast models and/or uses trained forecast models to generate forecasts in response to receipt of a forecast request or in accordance with a predefined schedule/frequency. In the example shown, system activity forecasting service 170 comprises preprocessing module 172, model training module 174, forecasting module 176, and active measure module 178.

System activity forecasting service 170 can use preprocessing module 172 to preprocess metric data (e.g., long term telemetry data) for use in connection with training forecast models. For example, preprocessing module 172 resamples the metric data collected by security platform 140 (e.g., system activity forecasting service 170) to obtain representative historical trend data. In some embodiments, preprocessing module 172 implements a feature pooling with respect to the metric data to obtain the resampled metric data. In some implementations, the feature pooling is a max pooling used to extract maximum metric values over a predetermined time period (e.g., to obtain daily maximum metric values).

System activity forecasting service 170 uses model training module 174 to train and/or update forecast models. Model training module 174 trains a forecast model based at least in part on recursive modeling of the resampled metric data. For example, the resampled metric data is segmented into inliers and outliers, and regressions or other functions can be fit with respect to the inliers.

In some embodiments, model training module 174 implements a Joint In-Out Clustering Regression (JioCR) model to train the forecast model. The JioCR may utilizes the Random Sample Consensus (RANSAC) algorithm to determine (e.g., converge on) the forecast model. However, various other techniques may be implemented, such as techniques that perform clustering to distinguish between inliers and outliers of metric data, and subsequently run regression on the inliers.

System activity forecasting service 170 can use forecasting module 176 to generate or update a forecast. In response to determining to generate/update a forecast, forecasting module 176 queries a corresponding forecast model to generate a metric for a particular metric (e.g., over a predetermined future time period). Forecasting module 176 may determine to generate/update a forecast in response to receiving a request from a client system (e.g., a system administrator) or the refreshing of a pre-configured dashboard that displays or otherwise provides a particular forecast. Additionally, or alternatively, forecasting module 176 may determine to generate/update a forecast according to a predefined schedule or frequency.

System activity forecasting service 170 can use active measure module 178 to determine an active measure based at least in part on a forecast generated by forecasting module 176. Active measure module 178 may determine the active measure by querying a mapping of forecasted metric values to active measures, or querying a mapping of active measures to relationships between forecasted metric values and current metric values. System activity forecasting service 170 can implement the active measure(s) to be implemented, or otherwise cause the active measure(s) to be implemented. Alternatively, system activity forecasting service 170 can provide the active measure as a recommendation to a user.

Returning to FIG. 1, suppose that a malicious individual (using client device 120) has created malware or malicious sample 130, such as a file, an input string, etc. The malicious individual hopes that a client device, such as client device 104, will execute a copy of malware or other exploit (e.g., malware or malicious sample 130), compromising the client device, and causing the client device to become a bot in a botnet. The compromised client device can then be instructed to perform tasks (e.g., cryptocurrency mining, or participating in denial-of-service attacks) and/or to report information to an external entity (e.g., associated with such tasks, exfiltrate sensitive corporate data, etc.), such as C2 server 150, as well as to receive instructions from C2 server 150, as applicable.

The environment shown in FIG. 1 includes three Domain Name System (DNS) servers (122-126). As shown, DNS server 122 is under the control of ACME (for use by computing assets located within enterprise network 110), while DNS server 124 is publicly accessible (and can also be used by computing assets located within network 110 as well as other devices, such as those located within other networks (e.g., networks 114 and 116)). DNS server 126 is publicly accessible but under the control of the malicious operator of C2 server 150. Enterprise DNS server 122 is configured to resolve enterprise domain names into IP addresses, and is further configured to communicate with one or more external DNS servers (e.g., DNS servers 124 and 126) to resolve domain names as applicable.

As mentioned above, in order to connect to a legitimate domain (e.g., www.example.com depicted as website 128), a client device, such as client device 104 will need to resolve the domain to a corresponding Internet Protocol (IP) address. One way such resolution can occur is for client device 104 to forward the request to DNS server 122 and/or 124 to resolve the domain. In response to receiving a valid IP address for the requested domain name, client device 104 can connect to website 128 using the IP address. Similarly, in order to connect to malicious C2 server 150, client device 104 will need to resolve the domain, “kj32hkjqfeuo32ylhkjshdflu23.badsite.com,” to a corresponding Internet Protocol (IP) address. In this example, malicious DNS server 126 is authoritative for *.badsite.com and client device 104's request will be forwarded (for example) to DNS server 126 to resolve, ultimately allowing C2 server 150 to receive data from client device 104.

Data appliance 102 is configured to enforce policies regarding communications between client devices, such as client devices 104 and 106, and nodes outside of enterprise network 110 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, website content, information input to a web interface such as a login screen, files exchanged through instant messaging programs, and/or other file transfers, and/or quarantining or deleting files or other exploits identified as being malicious (or likely malicious). In some embodiments, data appliance 102 is also configured to enforce policies with respect to traffic that stays within enterprise network 110. In some embodiments, a security policy includes an indication that network traffic (e.g., all network traffic, a particular type of network traffic, etc.) is to be classified/scanned by a classifier that implements a pre-filter model, such as in connection with detecting malicious or suspicious samples, detecting parked domains, or otherwise determining that certain detected network traffic is to be further analyzed (e.g., using a finer detection model).

In various embodiments, when a client device (e.g., client device 104) attempts to resolve an SQL statement or SQL command, or other command injection string, data appliance 102 uses the corresponding sample (e.g., an input string) as a query to security platform 140. This query can be performed concurrently with the resolution of the SQL statement, SQL command, or other command injection string. As one example, data appliance 102 can send a query (e.g., in the JSON format) to a frontend 142 of security platform 140 via a REST API. Using processing described in more detail below, security platform 140 will determine whether the queried SQL statement, SQL command, or other command injection string indicates an exploit attempt and provide a result back to data appliance 102 (e.g., “malicious exploit” or “benign traffic”).

In various embodiments, when a client device (e.g., client device 104) attempts to open a file or input string that was received, such as via an attachment to an email, instant message, or otherwise exchanged via a network, or when a client device receives such a file or input string, DNS module 134 uses the file or input string (or a computed hash or signature, or other unique identifier, etc.) as a query to security platform 140. In other implementations, an inline security entity queries a mapping of hashes/signatures to traffic classifications (e.g., indications that the traffic is C2 traffic, indications that the traffic is malicious traffic, indications that the traffic is benign/non-malicious, etc.). This query can be performed contemporaneously with receipt of the file or input string, or in response to a request from a user to scan the file. As one example, data appliance 102 can send a query (e.g., in the JSON format) to a frontend 142 of security platform 140 via a REST API. Using processing described in more detail below, security platform 140 will determine (e.g., using a malicious file detector that may use a machine learning model to detect/predict whether the file is malicious) whether the queried file is a malicious file (or likely to be a malicious file) and provide a result back to data appliance 102 (e.g., “malicious file” or “benign file”).

FIG. 2 is a block diagram of a system to forecast system activity or requirements according to various embodiments. In some embodiments, system 200 is implemented by at least part of system 100 of FIG. 1 and/or system 300 of FIG. 3. In some embodiments, system 200 can implement one or more of processes 900-1400 of FIGS. 9-14. System 200 may be implemented in one or more servers, a security entity such as a firewall, an endpoint, a security service provided as a software as a service.

In some embodiments, system 200 is an entity that trains a forecast model for providing forecasts of system activity, such as forecasts pertaining to network security services including capacity utilization, etc. Additionally, or alternatively, system 200 is an entity that generates forecasts based at least in part on the forecast model. For example, system 200 obtains historical information (e.g., historical trend data) and uses the forecast model to generate a forecast.

In the example shown, system 200 implements one or more modules in connection with enforcing a security policy configuration (e.g., a policy for handling malicious traffic), classifying network samples, such as multi-modal exploits, etc. System 200 comprises communication interface 205, one or more processor(s) 210, storage 215, and/or memory 220. One or more processors 210 comprises one or more of communication module 225, metric data collection module 227, metric data preprocessing module 229, parallel processing module 231, forecast request module 235, forecast generation module 237, active measure module 239, notification module 241, and user interface module 243.

In some embodiments, system 200 comprises communication module 225. System 200 uses communication module 225 to communicate with various nodes or end points (e.g., client terminals, firewalls, DNS resolvers, data appliances, other security entities, databases, etc.) or user systems such as an administrator system. For example, communication module 225 provides to communication interface 205 information that is to be communicated (e.g., to another node, security entity, etc.). As another example, communication interface 205 provides to communication module 225 information received by system 200, such as historical trend data, capacity utilization data/logs, system activity, etc. Communication module 225 is configured to receive an indication of historical data to be analyzed and used to train a forecast model or to use such a model to generate a forecast. Communication module 225 is configured to obtain, such as from client devices or other endpoints, forecast requests or requests for a forecast model to be trained. System 200 can use communication module 225 to query the third-party service(s) or other systems to obtain information to be used in connection with training a forecast model, to generate and provide a request, and/or to determine or recommend an active measure to be implemented based on the forecast. Communication module 225 is further configured to receive one or more settings or configurations from an administrator.

In some embodiments, system 200 comprises metric data collection module 227. System 200 uses metric data collection module 227 to obtain metric data (e.g., data pertaining to one or more metrics for system activity). Metric data collection module 227 may be configured to obtain the metric data from a database, such as a log data or repository for other data collected by a metric data pipeline. Additionally, or alternatively, metric data collection module 227 may obtain be configured to obtain the metric data directly from (e.g., processes running on) system nodes, such as firewalls, next generation firewall systems, client systems, servers, etc.

In some embodiments, the metric data comprises data for long-term telemetry metrics generated by next generation firewalls (NGFWs) or other systems or services, including, without limitation, network security systems or services. Examples of metric data include data pertaining to one or more characteristics or metrics of a tenant (e.g., resources deployed to provide services for a tenant), a device (e.g., a client device, a network node such as a switch or firewall, a server, etc.), a NGFW service, and/or a secure access service edge (SASE). Examples of metrics associated with the metric data include capacity, utilization, bandwidth, compute resources, latency, network or service speed, number of queries, types of queries, usage counts, firewall version (e.g., next generation firewall model type), security rules, dynamic IP addresses, security zones, SSL VPN tunnels, IPSEC VPN tunnels, etc. Various metrics may be captured in the metric data.

According to various embodiments, system 200 uses metric data collection module 227 to obtain relevant metric data for training a particular forecast model (e.g., a forecast model to generate a forecast with a particular metric) and/or obtain relevant metric data (e.g., historical trend data) with which system 200 generates a forecast using a predefined forecast model (e.g., pre-trained forecast model).

In some embodiments, system 200 comprises metric data preprocessing module 229. System 200 uses metric data preprocessing module 229 to preprocess metric data (e.g., metric data obtained by metric data collection module 227), such as in connection with preparing data to be used in training a forecast model or generating a forecast using a forecast model and pre-processed historical trend data. The preprocessing the metric data may include one or more of removing statistically non-relevant data, resampling the metric data, etc.

According to various embodiments, preprocessing the metric data comprises performing feature pooling with respect to the metric data. Metric data preprocessing module 229 can perform a max pooling to obtain a maximum value for the metric over specific time intervals. The specific time intervals may be predefined (e.g., based on parameters for the forecast model to be trained or used to generate a forecast). Alternatively, the specific time intervals can be determined based on one or more characteristics of the metric data. As an example, the system obtains resampled metric data based on performing a max pooling with respect to the metric data over the specific time intervals (e.g., daily metric maximums, etc.).

In some embodiments, system 200 comprises parallel processing module 231. System 200 uses parallel processing module 231 to obtain and/or allocate compute resources for perform parallel processing to train forecast models or to generate forecasts. As an example, parallel processing module 231 may use a cluster of virtual machines to train forecast models, and spin up virtual machines to train a plurality of forecast models in parallel. Parallel processing module 231 can additionally deallocate or spin-down compute resources after completion of the training/forecasting, etc. According to various embodiments, system 200 can train forecast models on a per-device basis, a per-tenant device, a per metric basis, a per-device-metric basis, a per-tenant-metric basis, etc. For example, system 200 can train in parallel a set forecast models respectively associated with different device identifiers for a per-device-metric. As another example, system 200 can train in parallel a set of forecast models respectively associated with different metrics.

In some embodiments, system 200 comprises forecast model training module 233. System 200 uses forecast model training module 233 to train a forecast model. In response to receiving a request to train a particular forecast model (e.g., the request comprising parameters or dimensions along which the forecast model is to be trained, such as the metric to be forecasted, the historical data to be used, the time intervals or granularity of the forecast, etc.), forecast model training module 233 obtains the pre-processed metric data (e.g., the resampled metric data) and trains the forecast model, such as based on a predefined training algorithm/process.

According to various embodiments, forecast model training module 233 implements a JioCR-based method for training forecast model. The JioCR-based method may be configured to implement a Random Sample Consensus (RANSAC) algorithm/process. Forecast model training module 233 may additionally or alternatively implement another technique that perform clustering to distinguish between inliers and outliers of metric data, and subsequently run regression on the inliers.

In some embodiments, system 200 comprises forecast request module 235. System 200 uses forecast request module 235 to obtain a request for a forecast. Forecast request module 235 may receive a forecast request from a client system, such as from a system administrator. Additionally, or alternatively, forecast request module 235 may receive the forecast request from a system or service that updates a particular forecast on a predetermined schedule or according to a predetermined frequency. In some embodiments, forecast request module 235 receives the forecast request in response to the refreshing of a dashboard that provides a forecast for a particular metric.

In some embodiments, system 200 comprises forecast generation module 237. System 200 uses forecast generation module 237 to generate a forecast. The forecast can be specifically generated for a particular metric, for a particular time period, or based on a particular set of historical trend data. In some embodiments, the forecast is a device-level forecast, a tenant-level forecast, a system-level forecast (e.g., a forecast that aggregates forecasting for all devices or all tenants on system 200).

In some embodiments, system 200 comprises active measure module 239. System 200 uses active measure module 239 to determine an active measure(s) to be performed based at least in part on a generated forecast. The system may query a mapping of forecasted metrics to active measures, etc. to determine the active measure(s) to be implemented. System 200 can provide the active measure(s) as a recommendation to a user (e.g., an administrator) or other system. Additionally, or alternatively, system 200 (e.g., active measure module 239) can implement the active measure(s) or otherwise cause the active measure(s) to be implemented (e.g., by another service or system).

In some embodiments, system 200 comprises notification module 241. System 200 uses notification module 241 to provide indications pertaining to forecast models or forecasts to other systems or services. Examples of the indications include an indication that the forecast model is trained, an indication of a status for the training of a particular forecast model, an indication of a forecast generated using a forecast model, an indication of parameters for a particular training model (e.g., a metric type, historical data used to train the forecast model, date the forecast model was trained, date when forecast model is to be next updated, etc.).

In some embodiments, system 200 comprises user interface module 243. System 200 uses user interface module 243 to configure and provide a user interface to a user, such as to a client system used by an administrator. User interface module 243 configures a user interface to provide the notifications or alerts, such as prompting the user of an active measure implemented based on the forecast, notifying the user of recommended active measures that could be implemented based at least in part on a particular forecast, alerting the user that the training of the forecast model is complete, alerting the user of characteristics pertaining to a particular forecast model (e.g., type of metric to be forecasted, accuracy, historical data used to train the forecast model, etc.), prompting the user that a malicious connection request (e.g., a request for a web service) is detected or has been handled, prompting the user to select an active measure to be performed with respect to particular traffic, etc.

According to various embodiments, storage 215 comprises one or more of filesystem data 260, metric data 262, and forecast data 264. Storage 215 comprises a shared storage (e.g., a network storage system) and/or database data, and/or user activity data.

In some embodiments, filesystem data 260 comprises a database such as one or more datasets. Examples of datasets include datasets comprising information pertaining to network activity, system activity, network services, network security services, network or system configurations, defined policies or policies implemented by a service (e.g., a network security service), etc. The information may be directed to one or more of: capacity, utilization, configuration, etc. Additional examples of datasets that may be stored include datasets comprising samples of connection requests, mappings of indications for connections requests or predicted authentication request classifications for network traffic to the authentication requests or hashes, signatures or other unique identifiers of the authentication requests, etc. Filesystem data 260 comprises data such as historical information pertaining to HTTP request data or network traffic, network activity, network service data, security service traffic/activity, a whitelist of network traffic profiles (e.g., hashes or signatures for the HTTP request data) or IP addresses deemed to be safe (e.g., not suspicious, benign, etc.), a blacklist of network traffic (e.g., authentication request) profiles deemed to be suspicious or malicious, etc.

In some embodiments, metric data 262 comprises data pertaining to one or more metrics for a network or system providing a service to network nodes. Examples of metrics include capacity, utilization, architecture, configuration, device type, bandwidth, speed, latency, usage counts, firewall version (e.g., next generation firewall model type), security rules, dynamic IP addresses, security zones, SSL VPN tunnels, IPSEC VPN tunnels, etc. However, various other metrics may be implemented. Metric data 262 may additionally comprise preprocessed or resampled metric data, such as resampled metric data obtained in connection with training a forecast model.

In some embodiments, forecast data 264 comprises (a) one or more forecast models trained by system 200, (b) one or more forecast models to be used by system 200 in connection with generating forecasts, (c) metadata for the forecast model (e.g., metric that is forecasted, historical data used to train the forecast model, a forecast model identifier, a date forecast model was generated, etc.), (d) configurations for training forecast models (e.g., an application or algorithm used to train the forecast models), etc.

According to various embodiments, memory 220 comprises executing application data 275. Executing application data 275 comprises data obtained or used in connection with executing an application such as an application for training a forecast model, an application for using a forecast model to generate a forecast, an application executing a hashing function, an application to extract information from connection requests, authentication requests, webpage content, an input string, an application to extract information from a file, or other sample, etc. In embodiments, the application comprises one or more applications that perform one or more of receive and/or execute a query or task, generate a report and/or configure information that is responsive to an executed query or task, and/or provide to a user information that is responsive to a query or task. Other applications comprise any other appropriate applications (e.g., an index maintenance application, a communications application, a machine learning model application, an application for detecting suspicious authentication requests, an application for detecting malicious network traffic or malicious/non-compliant applications such as with respect to a corporate security policy, a document preparation application, a report preparation application, a user interface application, a data analysis application, an anomaly detection application, a user authentication application, a security policy management/update application, etc.).

FIG. 3 is a block diagram of a system for training a forecast model according to various embodiments. In some embodiments, system 300 is implemented by at least part of system 100 of FIG. 1 and/or system 200 of FIG. 2. In some embodiments, system 300 can implement one or more of processes 900-1400 of FIGS. 9-14. System 300 may be implemented in one or more servers, a security entity such as a firewall, an endpoint, a security service provided as a software as a service.

In the example shown, system 300 may comprise a plurality of compute resources 305, 325, 350, and 375. The compute resources may be different virtual machines in one or more clusters. System 300 may spin-up, allocate, deallocate, and spin down the plurality of compute resources based on the then-current needs or parallel processing demands. In some embodiments, system 300 uses the plurality of compute resources to train a plurality of forecast models in parallel. The compute resources may implement the same training technique such as in the case that the forecast pertains to the same metric, device, system, and/or tenant. The compute resources may also implement different training techniques, such as when a plurality of forecasts directed to forecasting for different metrics is provided.

As illustrated, each compute resource can comprise feature pooling module 310, iterative RANSAC module 315, and forecast model module 320, such as in the case that the plurality of compute resources implement the same training technique. Feature pooling module 310 is used to preprocess metric data, such as to obtain resampled metric data that can be used to train a forecast model. In response to obtaining resampled metric data from feature pooling module 310, the particular compute resource (e.g., compute resource 305), the compute resource uses iterative RANSAC module 315 to train the forecast model, such as by implementing an iterative RANSAC technique as described herein. The compute resource uses forecast model module 320 to provide the trained forecast module such as by exposing the forecast module to queries for forecasts for the particular metric for which the forecast model is configured to forecast, etc.

FIG. 4 is an illustration of resampled metric data according to various embodiments. In the example shown, data 400 comprises resampled metric data. In some embodiments, the system implements a feature pooling to obtain resampled data. For example, the system implements a max pooling to obtain a maximum daily value for a particular metric(s).

FIG. 5 is an illustration of sampled subsets of resampled metric data according to various embodiments. In the example shown, data 500 corresponds to subsets of the resampled data, such as by iterative RANSAC module 315 of system 300. Subsets 505-540 are obtained by iteratively segmenting the resampled metric data to be used to train the forecast model. For example, the system generates a binary tree across the resampled metric data. As shown, the system (e.g., iterative RANSAC module 315) segments the resampled metric data into subsets that are inliers such as subsets 510, 520, 530, and 540, and subsets that are outliers such as subsets 515, 525, and 535.

FIG. 6 is an illustration of a capacity utilization forecast generated using a forecast model according to various embodiments. In the example shown, forecast 600 for a capacity utilization is generated based at least in part on a forecast model. The forecast model can be trained using a Joint In-Out Clustering Regression (JioCR) model, such as a RANSAC model. As illustrated, the forecast model can be used to generate forecasts based on different scenarios, such as: (a) a forecast based on a scenario in which a security service (e.g., a software that runs next generation firewalls) has been upgraded, (b) a forecast based on a scenario in which a next generation firewall or security service is not upgraded, (c) a forecast based on the next generation firewall being upgraded to a particular model. In some embodiments, the forecast additionally comprises an indication of an expected time period for an event to occur, such as a number of remaining capacity days associated with a particular scenario being forecasted.

FIG. 7A is an illustration of metric data for a particular metric. In the example shown, graph 700 represents metric data collected by a system, such as a metric data pipeline. The metric data pipeline can store information collected with respect to various system activity. The metric data may be stored in a database. Examples of metric data include resource utilization data, capacity data, network demand, next generation firewall service data, secure access service edge data, device data, network architecture, information pertaining to data ingress, information pertaining to data egress, site capacity, tunnel throughput ingress, tunnel throughput egress, site name, node type, and tunnel name, etc.

FIG. 7B is an illustration of a bandwidth capacity forecast generated using a forecast model based on resampled metric data according to various embodiments. In the example shown, forecast 750 plots the historical data, the forecast (e.g., a result of the forecast model), confidence bounds for the forecast, etc. The historical data (e.g., the historical trend data) can correspond to the results of resampling the metric data in graph 700. For example, the system applies a max pooling to obtain the maximum value over a particular time interval (e.g., a daily maximum value).

FIG. 8 is an illustration of a capacity forecast generated using a forecast model according to various embodiments. In the example shown, graph 800 illustrates forecasts for various metrics. For example, graph 800 plots historical trend data and a forecast 805 compute based on a forecast model and the historical trend data. Graph 800 can additionally plot confidence bounds 810 that indicate a predefined confidence level for forecast 805.

FIG. 9 is a flow diagram of a method for generating a forecast according to various embodiments. In some embodiments, process 900 is implemented by system 100 of FIG. 1, system 200 of FIG. 2, and/or system 300 of FIG. 3.

At 905, the system processes and recursively models the set of resampled metric data in connection with segmenting the metric data into relevant data and non-relevant data to obtain a forecast model for a system activity. The relevant data can be inliers within the set of resampled metric data, and the non-relevant data can correspond to outliers within the set of resampled metric data. In some embodiments, the set of resampled metric data pertains to the system activity.

According to various embodiments, the system can obtain the forecast model based at least in part on invoking process 1300 of FIG. 13, process 1400 of FIG. 14, process 1100 of FIG. 11, and/or process 1000 of FIG. 10.

In some embodiments, the forecast model for forecasting a particular system activity (e.g., capacity utilization, etc.) is trained based on the implementation of a resampled metric data pipeline and iterative resampled metric segmentation using a process that implements the Random Sample Consensus (RANSAC) algorithm until a predefined convergence criteria (e.g., a convergence threshold) is satisfied.

In some embodiments, the system adopts a breadth-first search binary tree search strategy that progressively partitions the resampled metric data into inliers and outliers using the RANSAC algorithm. This process recurs on the outliers' subset until all input data is either classified as an inlier or the remaining sample size is smaller than a pre-set minimum (e.g., defaulted to 7 samples). With the reduction in input data achieved through max resampling (e.g., performing max pooling), the RANSAC algorithm can operate more computationally efficiently. In some embodiments, the default kernel function for the RANSAC algorithm is linear regression. However, other types of kernel functions can be implemented, such as exponential or polynomial functions can also be employed based on the nature of the inlier input data.

Through the iterative breadth-first search using the RANSAC algorithm, the system segments the input data on a binary tree across the resampled metric sample. The most recent valid segmentation, determined by the minimum number of samples and model fitness criteria, can be used as the long-term forecast model. This method for training forecast models exhibits robustness to outliers and system state changes (e.g., OS or configuration updates). The system can link these segmentations to system logs, which thus enables the system to learn and understand the context of these segments. This context can then be used to detect security incidents or system operation events, enhancing overall system insights and responses.

At 910, the system generates a forecast based at least in part on the forecast model for the system activity.

At 915, a determination is made as to whether process 900 is complete. In some embodiments, process 900 is determined to be complete in response to a determination that no further models are to be determined/trained (e.g., no further forecast models are to be created), no further forecasts are to be generated, an administrator indicates that process 900 is to be paused or stopped, etc. In response to a determination that process 900 is complete, process 900 ends. In response to a determination that process 900 is not complete, process 900 returns to 905.

FIG. 10 is a flow diagram of a method for training a forecast model according to various embodiments. In some embodiments, process 1000 is implemented by system 100 of FIG. 1, system 200 of FIG. 2, and/or system 300 of FIG. 3.

At 1005, the system obtains in indication to train a forecast model. The system can obtain the indication to prepare the data for training the forecast model based on the system receiving a request or indication to provide a forecast, or a request to deploy a forecast model. The forecast model is to be configured to provide forecast with respect to a particular data metric(s), such as a metric pertaining to system activity. The system activity may be network activity, such as capacity utilization, bandwidth or the network data metrics. In some embodiments, the forecast corresponds to a security service forecast comprising one or more of (i) a per tenant forecast, (ii) a per device forecast, (iii) a next-generation firewall (NGFW) service forecast, and (iv) a secure access service edge (SASE) capacity forecast.

At 1010, the system obtains data. The system obtains the data from a metric data pipeline, such as log data collected for a particular network, a NGFW service, or a SASE.

At 1015, the system prepares the data. The system can prepare the data by pre-processing the data. In some embodiments, the system invokes process 1300 to prepare the data.

In some embodiments, pre-processing/preparing the data includes resampling the data (e.g., obtaining resampled metric data). For example, the system can perform a feature pooling with respect to the data, such as over predefined time intervals (e.g., in the case that the data is time series data). The predefined time intervals may be configured based on the parameters for the forecast model. As an illustrative example, the predefined time intervals is daily. However, various other time intervals may be implemented. According to various embodiments, the feature pooling comprises max pooling according to which the system determines/extracts the maximum value for each predefined time interval over the time period for which data is being analyzed (e.g., evaluated or used for training the forecast model). As an illustrative example, the system determines the daily maximum value for the particular metric.

At 1020, the system trains a model using a Joint In-Out Clustering Regression (JioCR) model. According to various embodiments, the system trains the model using the JioCR model until the earlier of (i) a predefined convergence criteria being satisfied, and (ii) a maximum tree depth being reached. The predefined convergence criteria and/or maximum tree depth may be predefined according to the parameters for the process of training forecast models.

At 1025, the system determines whether the trained model satisfies a predefined convergence criteria. The predefined convergence criteria can be defined by the parameters for the forecast model, such as a minimum fit the trained model must have relative to the training data (e.g., the prepared data, or resampled metric data) in order to be used as the forecast model for generating forecasts for the particular data metric.

In response to determining that the trained model satisfies the predefined convergence criteria, process 1000 proceeds to 1030 at which the system provides the trained model as the forecast model. The trained model can be used as the forecast model to generate forecasts for the corresponding data metric. Conversely, in response to determining that the trained model does not satisfy the predefined convergence criteria, process 1000 proceeds to 1035 at which the system provides a baseline model as the forecast model. For example, if the JioCR model does not generate a sufficiently accurate model, the system uses a default model (e.g., the baseline model) for generating forecasts.

At 1040, a determination is made as to whether process 1000 is complete. In some embodiments, process 1000 is determined to be complete in response to a determination that no further models are to be determined/trained (e.g., no further forecast models are to be created), an administrator indicates that process 1000 is to be paused or stopped, etc. In response to a determination that process 1000 is complete, process 1000 ends. In response to a determination that process 1000 is not complete, process 1000 returns to 1005.

FIG. 11 is a flow diagram of a method for generating a forecast using a forecast model according to various embodiments. In some embodiments, process 1100 is implemented by system 100 of FIG. 1, system 200 of FIG. 2, and/or system 300 of FIG. 3.

According to various embodiments, process 1100 is invoked by a system or service that determines to train a forecast model and/or to provide a forecast (e.g., a forecast with respect to system activity, such as network system capacity utilization). As an example, process 1300 is invoked by 910 of process 900 and/or 1210 of process 1200.

At 1105, the system obtains an indication to perform a forecast. The indication to perform the forecast may be generated based on the system receiving a request for a forecast (e.g., a user request for a forecast with respect to system activity, such as with respect to a particular data metric(s)), or based on the system determining to generate/update a forecast according to a predefined interval (e.g., to update a dashboard or existing forecast according to a predetermined schedule).

At 1110, the system obtains forecasted time points. The system can determine the time interval over which a forecast is to be generated, such as based on the forecast parameters comprised in the indication to perform the forecast. For example, the timeframe over which the forecast is to be provided, and splits the overarching timeframe into smaller time intervals (e.g., forecasted time points). As an illustrative example, if the system is requested to provide a forecast over the next year, the system may determine the smaller time intervals to be months, weeks, days, etc.

At 1115, the system selects a forecasted time point. In connection with generating the forecast, the system iterates over the determined forecasted time points to generate forecasts for each of the forecasted time points, which can be aggregated to determine the overall forecast (e.g., the forecast dataframe). At 1120, the system generates a forecast for the selected forecasted time point based at least in part on the forecasted model. At 1125, the system determines whether more forecasted time points are evaluated. For example, the system determines whether to generate a forecast for additional forecasted time points. In response to determining that more forecasted time points are to be evaluated (e.g., forecasts are to be generated for additional forecasted time points), process 1100 returns to 1115 and process 1100 iterates over 1115-1125 until no further forecasted time points are to be evaluated. Conversely, in response to determining that no further forecasted time points are to be evaluated, process 1100 proceeds to 1130.

At 1130, the system computes a confidence interval for each forecasted time point.

At 1135, the system updates a forecast dataframe with the computed confidence intervals. The forecast dataframe can aggregate the forecasts for the forecasted time points to generate a forecast for time interval defined by the forecast parameters comprised in the forecast request.

At 1140, the system provides the forecast based at least in part on the updated forecast dataframe. For example, the system generates a representation/visualization of the forecast dataframe and provides the representation/visualization as a forecast on a user interface.

At 1145, a determination is made as to whether process 1100 is complete. In some embodiments, process 1100 is determined to be complete in response to a determination that no further models are to be determined/trained (e.g., no further forecast models are to be created), an administrator indicates that process 1100 is to be paused or stopped, etc. In response to a determination that process 1100 is complete, process 1100 ends. In response to a determination that process 1100 is not complete, process 1100 returns to 1105.

FIG. 12 is a flow diagram of a method for generating a forecast according to various embodiments. In some embodiments, process 1200 is implemented by system 100 of FIG. 1, system 200 of FIG. 2, and/or system 300 of FIG. 3.

At 1205, the system processes and recursively models the set of resampled metric data in connection with segmenting the metric data into relevant data and non-relevant data to obtain a forecast model for a system activity. According to various embodiments, 1205 is implemented the same or similar manner as 905 of process 900.

At 1210, the system generates a forecast based at least in part on the forecast model for the system activity. According to various embodiments, 1210 is implemented the same or similar manner as 910 of process 900.

At 1215, the system provides the forecast. In some embodiments, the system forecast is provided to a user interface, such as to a user that requested the forecast, a system administrator, or a dashboard that is updated in real-time or according to a predefined frequency. In some embodiments, the forecast is provided to another system or service, such as a system or service that invoked process 1200. The forecast can be provided to a service that determines an active measure to be performed based on the forecast and causes the active measure to be performed or recommended to an administrator. As an example, in the case of the forecast pertaining to capacity utilization such as processing capacity, the service can use the forecast to obtain (e.g., procure) and allocate additional processing resources for deployment as capacity is utilization approaches the available capacity.

At 1220, a determination is made as to whether process 1200 is complete. In some embodiments, process 1200 is determined to be complete in response to a determination that no further models are to be determined/trained (e.g., no further forecast models are to be created), no further forecasts are to be generated, an administrator indicates that process 1200 is to be paused or stopped, etc. In response to a determination that process 1200 is complete, process 1200 ends. In response to a determination that process 1200 is not complete, process 1200 returns to 1205.

FIG. 13 is a flow diagram of a method for preprocessing metric data for use in training a forecast model according to various embodiments. In some embodiments, process 1300 is implemented by system 100 of FIG. 1, system 200 of FIG. 2, and/or system 300 of FIG. 3.

According to various embodiments, process 1300 is invoked by a system or service that determines to train a forecast model and/or to provide a forecast (e.g., a forecast with respect to system activity, such as network system capacity utilization). As an example, process 1300 is invoked by 905 of process 900, 1015 of process 1000, and/or 1205 of process 1200.

At 1305, the system obtains an indication to prepare data for training a forecast model. The system can obtain the indication to prepare the data for training the forecast model based on the system receiving a request or indication to provide a forecast, or a request to deploy a forecast model.

At 1310, the system obtains metric data from a metric data pipeline.

At 1315, the system selects a resampling frequency. As an illustrative example, the resampling frequency is daily. However, various other resampling frequencies may be implemented based on the metric to be evaluated/forecasted, or based on characteristics of the data retrieved from the metric data pipeline. Examples of the resampling frequency include per second, per day, per week, per month, per year, etc.

At 1320, the system selects a time interval for the metric data based on the selected resampling frequency. For example, the system obtains the metric data and determines the intervals over which the metric data is to be divided for use in training a forecast model. At 1325, the system samples the metric data during the selected time interval. For example, in the event that the forecast model is trained based on daily data or to provide forecasts for the service activity (e.g., capacity utilization) at the daily-level, the system obtains the metric data for each of the respective days over which the forecast model is to be trained.

At 1330, the system performs a feature pooling with respect to the sampled metric data during the selected time interval. In some embodiments, the feature pooling is used to extract a single representative value for each time interval within the time period with respect to which the forecast model is to be trained. As an illustrative example, the feature pooling may be a max pooling according to which the system obtains the maximum value over the selected time interval (e.g., the system determines the daily maximum value in the metric data for a particular day if the selected time interval is daily).

At 1335, the system determines whether more time intervals are to be resampled. For example, the system determines whether the resampled metric data comprises additional data for other time intervals to be resampled. In response to determining that more time intervals are to be resampled, process 1300 proceeds to 1320 and process 1300 iterates over 1320-1335. Conversely, in response to determining that no further time intervals are to be resampled, process 1300 proceeds to 1340.

At 1340, the system provides the resampled metric data. In some embodiments, the system provides the resampled metric data to the system or process that invoked process 1300. The system can provide the resampled metric data to a system or service that is configured to train a forecast model for a particular metric.

At 1345, a determination is made as to whether process 1300 is complete. In some embodiments, process 1300 is determined to be complete in response to a determination that no further models are to be determined/trained (e.g., no further forecast models are to be created), no further metric data is to be preprocessed or resampled, an administrator indicates that process 1300 is to be paused or stopped, etc. In response to a determination that process 1300 is complete, process 1300 ends. In response to a determination that process 1300 is not complete, process 1300 returns to 1305.

FIG. 14 is a flow diagram of a method for generating a forecast according to various embodiments. In some embodiments, process 1400 is implemented by system 100 of FIG. 1, system 200 of FIG. 2, and/or system 300 of FIG. 3.

At 1405, the system obtains an indication to train a forecast model. The system can obtain the indication to prepare the data for training the forecast model based on the system receiving a request or indication to provide a forecast, or a request to deploy a forecast model. The forecast model is to be configured to provide forecast with respect to a particular data metric(s), such as a metric pertaining to system activity. The system activity may be network activity, such as capacity utilization, bandwidth or the network data metrics. In some embodiments, the forecast corresponds to a security service forecast comprising one or more of (i) a per tenant forecast, (ii) a per device forecast, (iii) a next-generation firewall (NGFW) service forecast, and (iv) a secure access service edge (SASE) capacity forecast.

At 1410, the system obtains resampled metric data. The resampled metric data can correspond to a set of representative values selected from a database of metric data (e.g., a metric data pipeline) based on a selection criteria. An example of the selection criteria may be a maximum daily value for the metric from among the samples collected for the corresponding day.

At 1415, the system selects random subsets of resampled metric data.

At 1420, the system fits a set of models to the subsets of the selected random subsets of resampled metric data.

At 1425, the system evaluates the quality of the set of models. For example, the system evaluates how well each model fits with respect to the resampled metric data, which can be used as a proxy for how accurate the corresponding model may be in forecasting a metric value (e.g., a metric value at a future state/date).

At 1430, the system determines whether the convergence criteria is satisfied. The system can determine whether any of the models sufficiently fits the resampled metric data or is a sufficiently accurate forecast (e.g., sufficiently represents a long-term forecast).

In response to determining that the convergence criteria is not satisfied, process 1400 returns to 1415 and process 1400 iterates over 1415-1430 until the convergence criteria is satisfied. Conversely, in response to determining that the convergence criteria is satisfied, process 1400 proceeds to 1435.

At 1435, the system selects a forecast model from among the set of models satisfying the convergence criteria. In some embodiments, the system determines the particular model among the set of models that has the lowest uncertainty value or narrowest confidence interval to be the forecast model.

At 1440, the system provides the forecast model. The system provides the forecast model to a system or service that is configured to generate forecasts for the corresponding metric.

At 1445, a determination is made as to whether process 1400 is complete. In some embodiments, process 1400 is determined to be complete in response to a determination that no further models are to be determined/trained (e.g., no further forecast models are to be created), an administrator indicates that process 1400 is to be paused or stopped, etc. In response to a determination that process 1400 is complete, process 1400 ends. In response to a determination that process 1400 is not complete, process 1400 returns to 1405.

FIG. 15 is sample code for a joint rend segment and regression algorithm used to train a forecast model according to various embodiments. In the example shown, code 1500 implements a JioCR algorithm to train a forecast model. As illustrated, the JioCR algorithm implemented by code 1500 involves the recursive modeling of data by segmenting the data (e.g., the metric data) into inliers and outliers. The JioCR algorithm implemented by code 1500 fits a model on the data segments and refines the segmentation and model iteratively until convergence or a maximum tree depth is reached.

In some embodiments, the JioCR-based method for training forecast model utilizes the Random Sample Consensus (RANSAC) algorithm. However, the JioCR model is flexibly and allows for the use of any suitable process (e.g., algorithm) that can perform clustering to distinguish between inliers and outliers of metric data, and subsequently run regression on the inliers. This adaptable approach ensures that the model for training the forecast model can be tailored to various data characteristics and requirements.

FIG. 16 is sample code training a forecast model and using the forecast model for generating a forecast according to various embodiments. In the example shown, code 1600 implements a JioCR algorithm to train a forecast model, and to use the forecast model to generate a forecast.

As illustrated, code 1600 extends the JioCR (e.g., a joint trend segmentation algorithm) to a segmentation and regression model to robustly forecast long-term trends. The algorithm implemented by code 1600 comprises preprocessing the data (e.g., obtaining resampled metric data), fitting the segmentation and regression model with respect to the preprocessed data (e.g., subsets of the resampled metric data), evaluating the performance the fitted segmentation and regression model with respect to the preprocessed data, and, based on this evaluation, either utilizing the trained/derived model for forecasting (e.g., use the model as the forecast model) or reverting to a baseline model.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
process and recursively model a set of resampled metric data in connection with segmenting the metric data into relevant data and non-relevant data to obtain a forecast model for a system activity, wherein the set of resampled metric data pertains to the system activity;
generate a forecast based at least in part on the forecast model for the system activity; and
a memory coupled to the one or more processors and configured to provide one or more processors with instructions.

2. The system of claim 1, wherein processing and recursively modelling the resampled metric data to obtain the forecast model for the system activity comprises iteratively (a) selecting random subsets of the resampled metric data, (b) fitting a set of models to the random subsets, and (c) evaluating a quality of each of the set of models.

3. The system of claim 1, wherein processing and recursively modelling the resampled metric data to obtain the forecast model comprises recursively segmenting the resampled metric data into a set of segments, and performing a regression analysis with respect to the set of segments.

4. The system of claim 1, wherein the one or more processors are further configured to:
provide the forecast.

5. The system of claim 4, wherein the forecast is provided to a user interface configured to be displayed on a client system.

6. The system of claim 1, wherein the one or more processors are further configured to:
determine an active measure based at least in part on the forecast; and
cause the active measure to be implemented.

7. The system of claim 6, wherein the active measure comprises providing an alert to a user associated with the system.

8. The system of claim 1, wherein processing and recursively modelling a set of resampled metric data is performed using an iterative Random Sample Consensus (RANSAC) forecast model to obtain a forecast model for the system activity.

9. The system of claim 8, wherein the iterative RANSAC forecast model implements (a) selecting random subsets of the resampled metric data, (b) fitting of the set of models to the random subsets, and (c) evaluating of a quality of each of the set of models.

10. The system of claim 8, wherein the iterative RANSAC forecast model iteratives until a predetermined convergence threshold is satisfied.

11. The system of claim 10, wherein the forecast model for the system activity is obtained in response to the predetermined convergence threshold being satisfied.

12. The system of claim 8, wherein a kernel function for the iterative RANSAC forecast model is linear regression.

13. The system of claim 8, wherein the relevant data and non-relevant data corresponding to inliers and outliers obtained by the iterative RANSAC forecast model.

14. The system of claim 8, wherein the iterative RANSAC forecast model performs multi-trend segmentation of the set of resampled metric data.

15. The system of claim 8, wherein the forecast model for the system activity is determined based at least in part on selection of a set of most probable inliers.

16. The system of claim 15, wherein the forecast model for the system activity is determined based at least in part on performing a regression analysis with the selected set of most probable inliers.

17. The system of claim 1, wherein generating the forecast comprises estimating a long-term forecast with a predefined confidence interval threshold.

18. The system of claim 1, wherein the one or more processors are further configured to: the resampled metric data pipeline comprises:
perform a feature pooling with respect to metric data obtained from a metric data pipeline to obtain the set of resampled metric data.

19. The system of claim 18, wherein the feature pooling comprises a max pooling.

20. The system of claim 19, wherein the max pooling is performed to obtain daily maximum values for a device metric comprised in the metric data.

21. The system of claim 1, wherein the forecast comprises a long-term capacity resource forecast.

22. The system of claim 1, wherein the set of resampled metric data is obtained based at least in part on resampling system log data.

23. The system of claim 1, wherein the forecast model for system activity is based at least in part on performing a removal of outliers from the set of resampled metric data.

24. The system of claim 1, wherein the forecast comprises a security service forecast for network capacity.

25. The system of claim 1, wherein the forecast comprises a security service forecast for network demand.

26. The system of claim 1, wherein the forecast corresponds to a security service forecast comprising one or more of (i) a per tenant forecast, (ii) a per device forecast, (iii) a next-generation firewall (NGFW) service forecast, and (iv) a secure access service edge (SASE) capacity forecast.

27. A method, comprising:
processing and recursively modelling a set of resampled metric data in connection with segmenting the metric data into relevant data and non-relevant data to obtain a forecast model for a system activity, wherein the set of resampled metric data pertains to the system activity; and
generating a forecast based at least in part on the forecast model for the system activity.

28. A computer program product embodied in a non-transitory computer readable medium and comprising computer instructions for:
processing and recursively modelling a set of resampled metric data in connection with segmenting the metric data into relevant data and non-relevant data to obtain a forecast model for a system activity, wherein the set of resampled metric data pertains to the system activity; and
generating a forecast based at least in part on the forecast model for the system activity.
